(19) United States
(12) Patent Application Publication
(10) Pub. No.: US 2013/0154348 A1
(43) Pub. Date: Jun. 20, 2013

(54) POWER FEEDING SYSTEM AND METHOD

(71) Applicants: Hiroo Hongo, Tokyo (JP); Masaki Yasukawa, Tokyo (JP)

(72) Inventors: Hiroo Hongo, Tokyo (JP); Masaki Yasukawa, Tokyo (JP)

(73) Assignees: NEC MAGNUS COMMUNICATIONS, LTD., Tokyo (JP); NEC CORPORATION, Tokyo (JP)

(21) Appl. No.: 13/817,950

(22) PCT Filed: Aug. 4, 2011
(86) PCT No.: PCT/JP2011/067864

§ 371 Date: Feb. 20, 2013

(30) Foreign Application Priority Data
Aug. 23, 2010 (JP) 2010-186376

(51) Int. Cl. H04B 3/54

(52) U.S. Cl. CPC H04B 3/54
USPC 307/1

(57) ABSTRACT

A center device performing power feed control generates a control signal for controlling supply and suspension of power to a main load of a remote terminal and transmits the control signal by superimposing the control signal on the power to be supplied to the remote terminal. The remote terminal includes a power-receiving side unit, a switch that connects the power-receiving side unit with the main load when the switch is on and disconnects the power-receiving side unit from the main load when the switch is off, and a control signal receiver that receives the control signal superimposed on the power transmitted from the center device to turns the switch on or off in accordance with the control signal received at the control signal receiver.

### TECHNICAL FIELD

The present invention relates to a power feeding system including a control device for supplying power and a controlled device that receives power from the control device as well as to a power feeding method thereof.

### BACKGROUND ART

In recent years, with the development of information communication technologies, various kinds of devices have come to be connected to and used in networks. However, there are many kinds of devices that are not always installed at places where power can be supplied easily, such as various sensors for detection of the temperature and the intensity of light in factories and buildings as well as for detection of the opening and closing of doors, windows, etc., security cameras, radio LAN (Local Area Network) access points, etc. Further, there are some kinds of devices, connecting which it was not necessary to consider a power supply (such as a fixed-line phone that is supplied with power from the telephone line), but which have come to require a power supply due to the additional functions for LAN, such as an IP phone.

As the method of enabling power supply while permitting data communication with such kinds of devices, there is a known technology called PoE (Power over Ethernet), for example. PoE has been disclosed in Patent Literature 1 and others.

The above-described PoE is assumed to supply DC power to relatively low-power devices through a LAN cable. Accordingly, the exchangeable power between a PSE (Power Sourcing Equipment: power-feeding side unit) performing power feeding control and a PD (Powered Device: power receiving side unit) receiving power from the PSE is limited.

Further, PoE is a technology that enables data exchange and power supply but is not the entity that can perform control on the state of each of controlled devices including PD (which will be referred to hereinbelow as remote terminals), such as, for example, on/off control of power supply to the circuit that realizes the principal function of the remote terminal (monitoring camera, radio communicator, sensor, telephony and other functions) or the main load (device). In a word, PoE cannot control the state of the remote terminal through the control device (which will be referred to hereinbelow as a center device) including the above-described PSE.

A technology for enabling activation control of the power supply to the main load of a remote terminal has been disclosed in, for example, Patent Literature 2. Patent Literature 2 discloses a technology of restarting power supply to the principal part (main load) of a remote terminal (communication device), by converting the signal externally received via a communication interface into electric power by means of a high sensitivity rectifier so that the resultant electric power actuates a controller to thereby activate the power source for supplying power to the main load by means of the controller.

However, the technology described in the above-described Patent Literature 2 shows the technique for restarting power supply to the main load only, but does not suggest any technique for stopping power supply to the main load (for switching the remote terminal into the waiting (suspended) state). Further, since this technology needs special parts (high sensitivity rectifiers) and since this technology cannot be realized by using standard parts, this causes concern that the cost of the remote terminal will increase.

### RELATED ART LITERATURE

### Patent Literature

Patent Literature 1: Japanese Patent Laid-Open No. 2008-52935

Patent Literature 2: Japanese Patent Laid-Open No. 2007-25933

### SUMMARY

It is therefore an object of the present invention to provide a power feeding system and a method thereof in which a center device can control supply/suspension of power to a main load of a remote terminal, without causing any cost increase.

In order to attain the above object, a power feeding system according to an exemplary aspect of the present invention includes:
a remote terminal including a power-receiving side unit that receives externally supplied power, a main load as a circuit or device that realizes the principal function thereof, and a switch that connects the power-receiving side unit with the main load when the switch is on and disconnects the power-receiving device from the main load when the switch is off; and,
a center device including a power-sourcing side unit that performs power feed control to the remote terminal and a control signal transmitter that generates a control signal for controlling the supply and suspension of power to the main load and for transmitting the control signal by superimposing the control signal on the power supplied from the power sourcing side unit to the remote terminal, and
the remote terminal further includes
a control signal receiver that receives the control signal transmitted by being superimposed on the power supplied from the center device to turn the switch on or off in accordance with the control signal.

A power feeding method according to an exemplary aspect of the present invention is a method wherein
a center device including a power-source side unit for performing power feed control to a remote terminal, generates a control signal for controlling the supply and suspension of power to a main load as a circuit or device that realizes the principal function of the remote terminal and transmits the control signal by superimposing the control signal on the power supplied to the remote terminal; and
the remote terminal includes a power-receiving side unit that receives externally supplied power, the main load, a switch that connects the power-receiving side unit with the main load when the switch is on and disconnects the power-receiving device from the main load when the switch is off, and a control signal receiver that receives the control signal transmitted by being superimposed on the power supplied from the center device,
the switch is turned on or off in accordance with the control signal received at the control signal receiver.

### BRIEF DESCRIPTION OF DRAWINGS

FIG. 1 is a schematic diagram showing one configurational example of a power feeding system of the present invention.

FIG. 2 is a block diagram showing a configuration of a power feeding system of the first exemplary embodiment.

FIG. 3 is a table chart showing one example of the power control operation of the power feeding system shown in FIG. 2.

FIG. 4 is a block diagram showing a configuration of a power feeding system of the second exemplary embodiment.

### EXEMPLARY EMBODIMENT

Next, the present invention will be described with reference to the drawings.

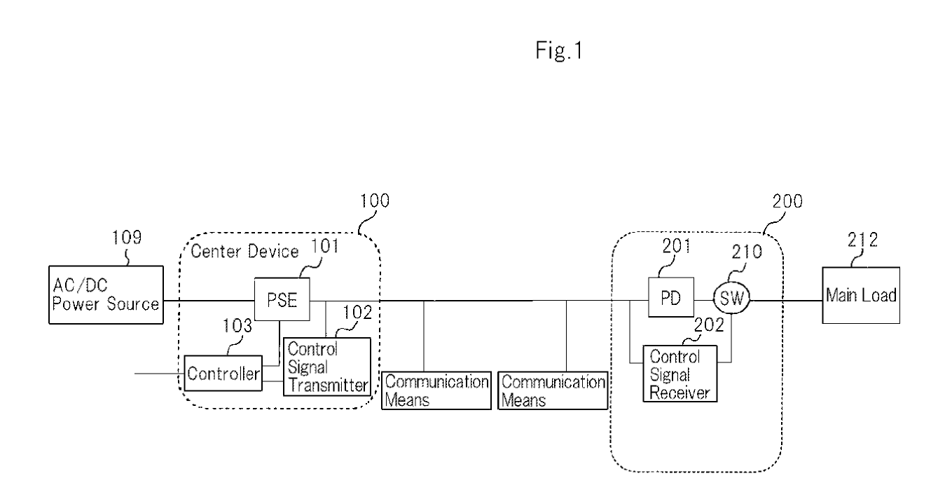

FIG. 1 is a schematic diagram showing one configurational example of a power feeding system of the present invention.

As shown in FIG. 1, the power feeding system of the present invention includes center device 100 and remote terminal 200. Center device 100 is connected with AC/DC power source 109 that converts AC power supplied from the power distribution system into DC power so that DC power is supplied from the AC/DC power source 109. Center device 100 supplies the DC power output from AC/DC power source 109 to remote terminal 200.

Connected to remote terminal 200 is main load 212, which is a circuit, device or the like that realizes the principal function (monitoring camera, radio communicator, sensor, telephony or other functions) of the remote terminal 200. AC/DC power source 109 shown in FIG. 1 may be incorporated in center device 100. Main load 212 may be incorporated in remote terminal 200. Further, center device 100 and remote terminal 200 each may include a communication means for exchanging data therebetween.

Center device 100 includes PSE 101 that performs power feed control over remote terminal 200, control signal transmitter 102 that generates control signals for controlling supply/suspension of power to main load 212, and controller 103 that controls the operations of PSE 101 and control signal transmitter 102. A control signal generated at control signal transmitter 102 is superimposed on the DC power output from PSE 101 and is transmitted to remote terminal 200.

Remote terminal 200 includes PD 201 that receives the power supplied from center device 100 and supplies the power to main load 212, switch 210 that makes a connection between PD 201 and main load 212 when the switch is on and cuts off PD 201 from main load 212 when the switch is off, and control signal receiver 202 that receives the control signal that is superimposed on the DC power and transmitted from center device 100 to turn switch 210 on or off in accordance with the control signal.

Here in the present embodiment, for convenience sake the device for performing power feed control, incorporated in center device 100 is named PSE 101 while the device for receiving power from center device 100, incorporated in remote terminal 200 is named PD 201. However, strictly speaking, these devices do not imply the PSE and PD defined in PoE. PSE 101 and PD 201 in the present embodiment have the same functions as those of the PSE and PD defined in PoE, but the feedable power from PSE 101 to PD 201 should be limited to the value defined in PoE because the connection therebetween is not limited to the connection using a LAN cable as in PoE. Further, the PD defined in PoE enables the PSE to perform power feed control by causing a predetermined load current to flow in accordance with the DC voltage supplied from the PSE, PD 201 of the present embodiment does not need to have this function.

Center device 100 can be realized by means of a well-known information processing apparatus such as a computer or the like, which includes the above-described PSE 101 and executes the predetermined process in accordance with a program, for example.

Remote terminal 200 is an electric device such as a kind of sensor, monitoring camera, illumination device, IP telephone or the like, including the above-described PD 201 and switch 203.

Controller 103 can be realized by means of a well-known processing apparatus including CPU or DSP, memories, logical circuits and the like for executing the necessary processes in accordance with a program. When center device 100 is realized by means of an information processing apparatus, the information processing apparatus may include the function of controller 103.

Control signal transmitter 102 and control signal receiver 202 may consist of a circuit that transmits and receives signals, for example by a well-known frequency modulation scheme or amplitude modulation scheme, using a predetermined frequency band.

In the power feeding system shown in FIG. 1, DC power is supplied from PSE 101 provided in center device 100 to PD 201 provided in remote terminal 200, and PD 201 supplies power to main load 212 via switch 210. Accordingly, center device 100 is able to control supply/suspension of power to the entire remote terminal 200 by turning PSE 101 on and off. Further, when power is supplied to PD 201 from PSE 101, center device 100 generates a control signal for controlling supply/suspension of DC power to main load 212 at control signal transmitter 102 and transmits the control signal by superimposing the signal on the DC power supplied from PSE 101 to PD 201.

Remote terminal 200 extracts the control signal superimposed on the DC power and receives the signal at control signal receiver 202. Control signal receiver 202 turns switch 210 on or off in accordance with the control signal received from center device 100. On this occasion, the power necessary for operation can be supplied to control signal receiver 202 from the output terminal of PD 201.

In the power feeding system shown in FIG. 1, main load 212 and control signal receiver 202 are connected as load to PSE 101 via PD 201. Accordingly, it is possible for center device 100 to determine whether or not remote terminal 200 is connected, by detecting the presence of the load current flowing to control signal receiver 202 even when no power is supplied to main load 212. The load current may be detected at PSE 101, for example. The load current can be detected by using a well-known current detecting circuit including a current detection resistor and the like. Whether remote terminal 200 is connected or not can be determined by controller 103.

Center device 100 can also control supply/suspension of DC power to main load 212 during connection to remote terminal 200 by turning switch 210 of remote terminal 200 on or off by means of the control signal transmitted from control signal transmitter 102. As a result, it becomes possible to control supply/suspension of power to main load 212 of remote terminal 200 by center device 100.

Further, the power feeding system shown in FIG. 1 does not need any special parts (high sensitivity rectifier) as in the technology described in the aforementioned Japanese Patent Laid-Open No. 2007-25933 and can be configured with general-purpose parts, hence the cost of remote terminal 200 will not be increased.

As a result, according to the power feeding system of the present embodiment, it is possible to control supply/suspension of power to main load 212 of remote terminal 200 by means of center device 100 without causing any cost increase.

Here, since it is expected that a relatively large load current flows through main load 212 while a relatively small load current flows through control signal receiver 202, center device 100 (controller 103) can determine whether or not power is supplied to main load 212, from the change in the load current detected at PSE 101. That is, when power has been supplied to main load 212 by the control signal, if the power supply to main load 212 is suspended as switch 210 is turned off by, for example, operating a power button (not illustrated) or the like provided for remote terminal 200, controller 103 can detect suspension of the power supply to main load 212, based on the value of the load current detected at PSE 101. Conversely, when power supply to main load 212 has been suspended by the control signal, if power is supplied to main load 212 as switch 210 is turned on by operating the aforementioned power button or the like, controller 103 can detect the power being supplied, based on the value of the load current detected at PSE 101. As a result, controller 103 can transmit a necessary control signal in accordance with the actual on/off state of switch 210 even if the on/off state of switch 210 is different from the indication of the control signal transmitted to remote terminal 200.

Accordingly, in the power feed system shown in FIG. 1 it is also possible to control supply/suspension of power to main load 212 of remote terminal 200 by means of both center device 200 and remote terminal 200. Though FIG. 1 shows a configurational example in which control signal receiver 202 directly turns switch 210 on or off, if remote terminal 200 includes the aforementioned power button or the like, remote terminal 200 may include a controller or the like including a drive circuit for turning switch 210 on or off in accordance with indications of the control signal and the power button. The controller can be realized with a well-known processing apparatus including CPU or DSP, memories, logical circuits and the like for executing the necessary process in accordance with a program.

Though the present embodiment was described taking an example in which DC power is supplied from center device 100 to remote device 200, the present invention can be applied to a configuration for supplying AC power from center device 100 to remote device 200 if the supplied power is of a low enough frequency compared to the frequency band used for communication of the control signal and the frequency band used for the communication means.

Next, the exemplary embodiment of the present invention will be described using the drawings.

### The First Exemplary Embodiment

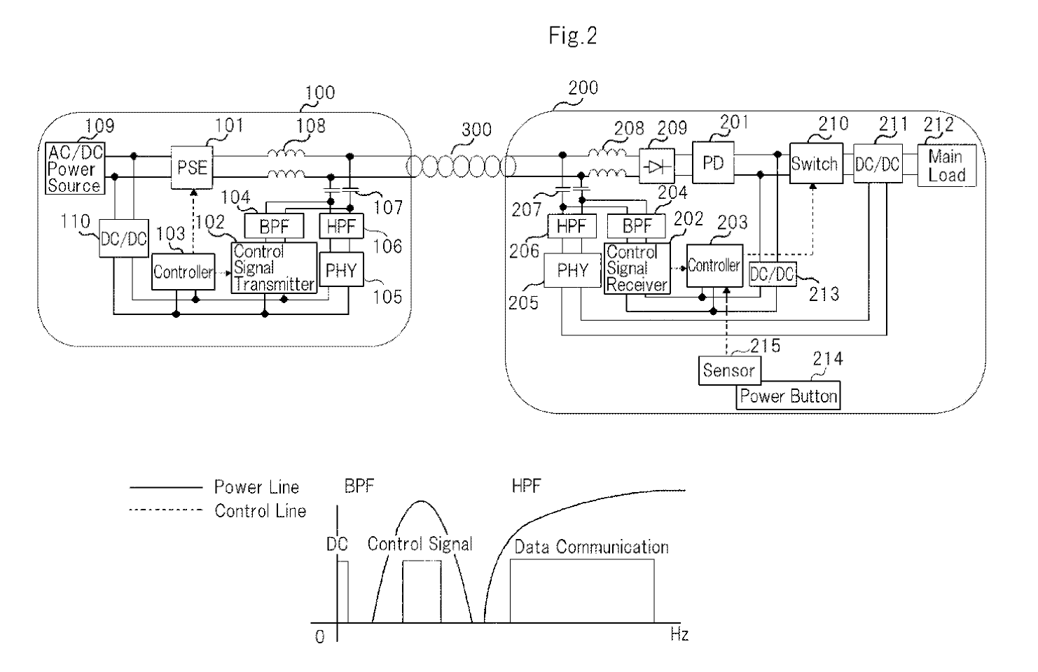

FIG. 2 is a block diagram showing the configuration of the power feeding system of the first exemplary embodiment. The power feeding system of the first exemplary embodiment is a configurational example in which center device 100 and remote terminal 200 are connected by a two-wire type power supply cable (cable 300).

As shown in FIG. 2, center device 100 includes PSE 101, control signal transmitter 102, controller 103, BPF 104, PHY 105, HPF 106, capacitor 107, inductor 108, AC/DC power source 109 and DC/DC 110.

AC/DC power source 109 is an AC/DC converter for converting AC power supplied from the power distribution system into DC power.

PSE 101 is a device for performing control of power supply to remote terminal 200. PSE 101 supplies the DC power output from AC/DC power source 109 to remote terminal 200 via inductor 108 and cable 300.

Inductor 108 removes the AC component included in the DC power output from PSE 101.

Controller 103 controls the operations of PSE 101 and control signal transmitter 102. Controller 103 includes an interface with an input/output device (not illustrated) and can control on/off of PSE 101 and supply/suspension of DC power to main load 212 of remote terminal 200, in accordance with, for example the instructions of the operator through the input device,

Control signal transmitter 102, following the indication of controller 103, generates a control signal to control supply/suspension of DC power to main load 212 of remote terminal 200.

BPF (Band Pass Filter) 104 removes the signal components other than the frequency band used for communication of the control signal, from the control signal generated by control signal transmitter 102.

PHY (Physical Layer) 105 is a communication means having the function of a physical layer conforming to a well-known communication protocol, in order to exchange various kinds of data (perform data communication) with remote terminal 200.

HPF (High Pass Filter) 106 removes the signal components other than the frequency band used for data communication with remote terminal 200, from the data signals exchanged by PHY 106.

Capacitor 107 removes the DC component from the DC power output from PSE 101. The control signal generated at control signal transmitter 102 and the data signal to be transmitted from PHY 105 to remote terminal 200 are passed through capacitor 107 and superimposed on the DC power output from PSE 101. The data signal received at data PHY 105, transmitted from remote terminal 200 is extracted through capacitor 107.

DC/DC 110 converts the DC voltage output from AC/DC power source 109 into a power source voltage (DC voltage) for CPU 103, control signal transmitter 102 and PHY 105.

As shown in FIG. 2, remote terminal 200 includes PD 201, control signal receiver 202, controller 203, BPF 204, PHY 205, HPF 206, capacitor 207, inductor 208, diode bridge 209, switch 210, DC/DC 211, main load 212, DC/DC 213 and power button 214.

Main load 212 is a power-consuming circuit, device or the like, which realizes the principal function of remote terminal 200 (such as monitoring camera, radio transmitter, sensor, telephony or other functions).

Power button 214 is a button for the operator or the like to indicate or input supply/suspension of DC power to main load 212. The result of operation of power button 214 (ON or OFF indication) is output to controller 203.

Sensor 215 detects the occurrence of a predetermined event. The result of detection of sensor 215 is output to controller 203, and is used to supply/suspend the DC power to main load 212. Sensor 215, for example, can be considered as a temperature sensor of this kind for supplying or suspending power to main load 212 when main load 212 or the ambient temperature is equal to or greater than a threshold, or can be considered as an optical sensor for supplying or suspending power to main load 212 in accordance with ambient brightness in night time, daytime, etc.

PD 201 is a device that receives DC power supplied from center device 100 via cable 300 and supplies the power to main load 212.

Inductor 208 removes the AC component included in the DC power supplied from center device 100 via cable 300.

Control signal receiver 202 receives a control signal transmitted from control signal transmitter 102 of center device 100 and outputs the control signal to controller 203.

Controller 203 includes the interface with power button 214 and sensor 215 and turns switch 210 on (connects) or off (disconnects) in accordance with the result of detection from sensor 215 and the control signal received by control signal receiver 202.

Switch 210 connects or disconnects PD 201 and DC/DC 211 in accordance with the indication from controller 203.

DC/DC 211 converts the DC voltage output from PD 201 to the power source voltage (DC voltage) for main load 212 when switch 210 is on. The power source voltage (DC voltage) output from DC/DC 211 is supplied to main load 212 and PHY 205. It should be noted that when the power source voltage (DC voltage) for main load 212 is output from PD 201, DC/DC 211 is not needed.

BPF 204 removes the signal components other than the frequency band used for communication of the control signal to extract the control signal transmitted from control signal transmitter 102 of center device 100.

PHY 205 is a communication means having the function of a physical layer conforming to a well-known communication protocol, in order to exchange various kinds of data (perform data communication) with center device 100.

HPF 206 removes the signal components other than the frequency band used for data communication with center device 100, from the data signals exchanged by PHY 105.

Capacitor 207 removes the DC component from the CD power supplied from center device 100. The control signal and data signal superimposed on the DC power and transmitted from center device 100 are extracted via capacitor 207. The data signal to be transmitted from PHY 205 to center device 100 is superimposed on the DC power supplied from center device 100 via capacitor 207.

Diode bridge 209 alternates polarity as necessary so that the DC power supplied from center device 100 is input to PD 201 with the same polarity.

DC/DC 213 converts the DC voltage output from PD201 into a power source voltage (DC voltage) for controller 203 and control signal receiver 202.

In center device 100 shown in FIG. 2, control of power supply from PSE 101 to remote terminal 200 is implemented. The DC power output from PSE 101 is superimposed on a control signal that is generated at control signal transmitter 102 for indicating supply/suspension of the DC power to main load 212 and the output signal (data signal) from PHY 105 and that is transmitted to remote terminal 200.

In remote terminal 200, the DC power output from center device 100 is kept with its polarity fixed by diode bridge 209 and input to PD 201. Remote terminal 200 includes switch 210 between PD 201 and main load 212. Controller 203 performs turning switch 210 on/off control. Controller 203 turns switch 210 on or off in accordance with the result of operation of power button 214, the result of detection from sensor 215 and the control signal received at control signal receiver 202. If the ON/OFF indication of the control signal does not match the ON/OFF indication given by power button 214 or sensor 215, controller 203 can give priority to the ON/OFF indication given by power button 214 or sensor 215.

On the other hand, in remote terminal 200, capacitor 207 removes the DC component from the DC power supplied from center device 100 and extracts the control signal and the data signal received by PHY 205. The control signal, from which unnecessary signal components other than the frequency band has been removed by BPF 204, is received by control signal receiver 202. The data signal, from which unnecessary signal components other than frequency band (the low-frequency domain) has been removed through HPF 206, is received by PHY 205.

Since the control signal and the data signal are transmitted and received through different frequency bands (because these are signals modulated by different carrier frequencies), the frequency components to be received at control signal receiver 202 and PHY 205 are extracted by BPF 204 and HPF 206, respectively.

Similarly to main load 212, PHY 205 is supplied with DC power from DC/DC 211 which is connected to the output terminal of switch 210.

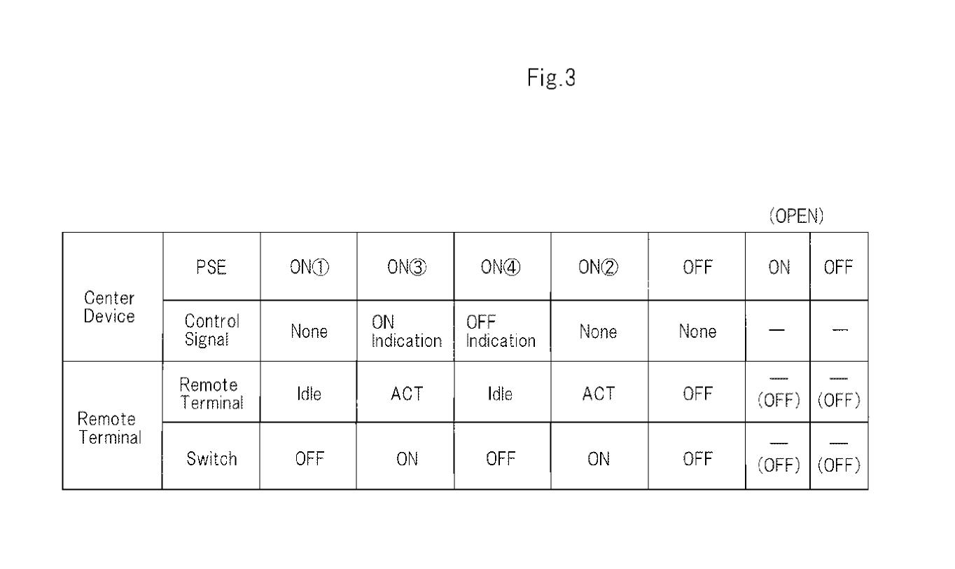

FIG. 3 is a table chart showing one example of power source control operation in the power feeding system shown in FIG. 2.

As shown in FIG. 3, when PSE 101 of center device 100 is turned on by instructions from the operator etc.,

[Equation 1]

(ON\textcircled{1})

then, DC power is supplied from PSE 101 to remote terminal 200. At this stage, remote terminal 200 resides in the idle state in which no DC power is supplied to main load 212 while DC power is supplied to controller 203 and control signal receiver 202.

In the idle state in remote terminal 200

[Equation 2]

(ON\textcircled{1}),

when, for example, power button 214 provided for remote terminal 200 is turned on by the operator etc., controller 203 turns switch 210 on in accordance with the operated result of power button 214. At this moment, remote terminal 200 transfers to the active (ACT) state

[Equation 3]

(ON\textcircled{2})

so that power is supplied to main load 212. By detecting change in the load current by PSE 101, transition of remote terminal 200 to the active (ACT) state

[Equation 4]

(ON\textcircled{2})

is detected by center device 100.

Further, in the idle state in remote terminal 200

[Equation 5]

(ON\textcircled{1}),

when an ON indication is transmitted as a control signal from control signal transmitter 102 of center device 100, remote terminal 200 turns switch 210 on by means of controller 203 in accordance with the control signal received at control signal receiver 202. At this moment, remote terminal 200 transfers to the active (ACT) state

[Equation 6]

(ON\textcircled{3}),

so that power is supplied to main load 212.

On the other hand, in the active (ACT) state in remote terminal 200

[Equation 7]

(ON\textcircled{3}),

when an OFF indication is transmitted as a control signal from control signal transmitter 102 of center device 100, remote terminal 200 turns switch 210 off by means of controller 203 in accordance with the control signal received at control signal receiver 202. At this moment, remote terminal 200 returns to the idle (Idle) state

[Equation 8]

(ON\textcircled{4})

in which no power is supplied to main load 212.

Further, in the active (ACT) state in remote terminal 200

[Equation 9]

(ON\textcircled{3}),

when power button 214 provided for remote terminal 200 is turned off by, for example the operator etc., controller 203 turns switch 210 off in accordance with the operated result of power button 214. At this moment, remote terminal 200 returns to the idle (Idle) state in which no power is supplied

[Equation 10]

(ON\textcircled{4}).

By detecting change in the load current by PSE 101, transition of remote terminal 200 to the idle (Idle) state

[Equation 11]

(ON\textcircled{4})

is detected by center device 100.

As PSE 101 of center device 100 is turned off by an indication from the operator etc., all the power supply to remote terminal 200 is stopped so that remote terminal 200 enters the non-active state (OFF).

It should be noted that “OPEN” shown in FIG. 3 represents the state in which center device 100 and remote terminal 200 are not connected. In this case, regardless of the ON/OFF state of PSE 101, remote terminal 200 remains in the non-active state (OFF) in which switch 210 is off. Center device 100 can detect that remote terminal 200 is disconnected since no load current can be detected by PSE 101. In this case, PSE 101 needs to be suspended from outputting DC power in consideration of safety.

According to the power feeding system of the first exemplary embodiment, while control of power feeding to remote terminal 200 is implemented at center device 100, supply/suspension of power to main load 212 can be controlled by transmitting a control signal from center device 100 to remote terminal 200 when power is supplied to remote terminal 200, and it is also possible to control supply/suspension of power to main load 212, locally on the remote terminal 200 side by using power button 214 or sensor 215. Further, even if the ON/OFF state of switch 210 is different from the indication of the control signal transmitted to remote terminal 200, center device 100 can transmit a necessary control signal in accordance with the current ON/OFF state of switch 210. Accordingly, the supply/suspension of power to main load 212 of remote terminal 200 can be controlled by both center device 100 and remote terminal 200.

Further, since the power feeding system of the present exemplary embodiment can be configured using versatile parts, the cost for remote terminal 200 will not increase.

Accordingly, it is possible for center device 100 to control the supply/suspension of power to main load 212 of remote terminal 200 without an increase in cost.

Further, since in the first exemplary embodiment, center device 100 and remote terminal 200 are connected by two-wire type power supply cable (cable 300), the suppliable power to remote terminal 200 is not limited as in the above-described PoE using a LAN cable.

### The Second Exemplary Embodiment

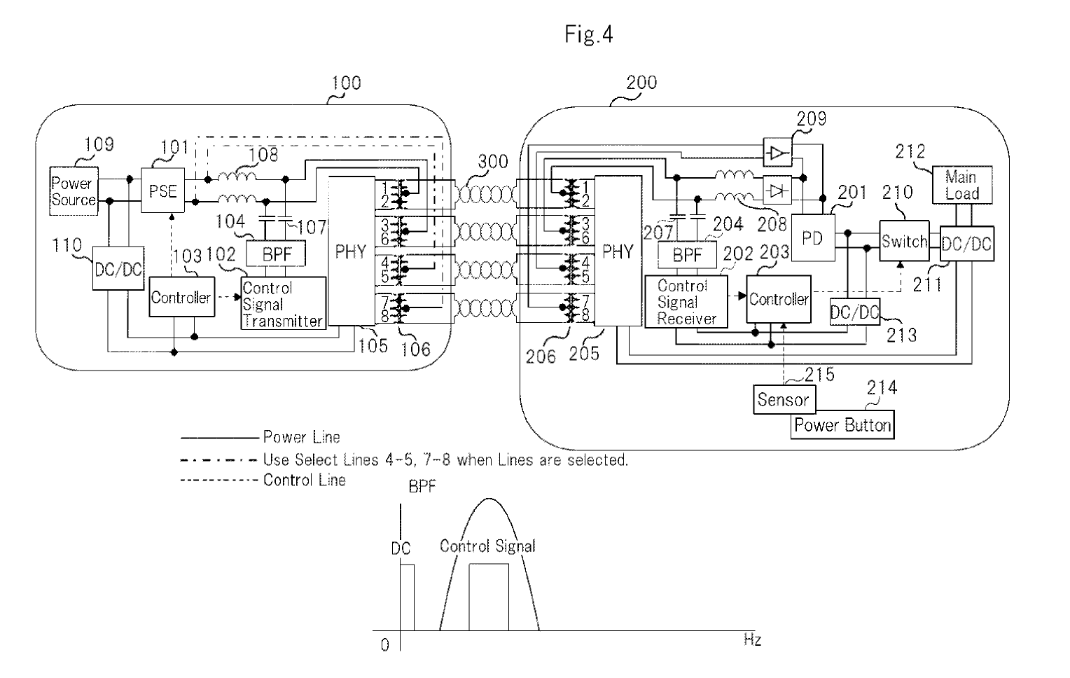

FIG. 4 is a block diagram showing the configuration of a power feeding system of the second exemplary embodiment. The power feeding system of the second exemplary embodiment presents a configurational example in which center device 100 and remote terminal 200 are connected by a UTP (Unshielded Twisted Pair) cable (cable 300) used for LAN etc. FIG. 4 shows a configurational example in which a 4-pair UTP cable is used to connect center device 100 with remote terminal 200.

PHYs 105 and 205 shown in FIG. 4 are communication devices having the function of a physical layer conforming to Ethernet (registered trademark). In Ethernet (registered trademark), two lines forming a pair are used to exchange pulsed data signals varying positive and negative voltages. Accordingly, PHYs 105 and 205 are connected to each other by a pulse transformer for every two lines that form a pair. The DC power is transferred using the middle point of the pulse transformer corresponding to the pair of lines used for transmission of the data signal, for example, and the middle point of the pulse transformer corresponding to the pair of lines used for reception of the data signal. The lines (pair) used for transfer of DC power may use, for example, the lines used for data exchange (lines 1-2, 3-6 in the example shown in FIG. 4) or may use supplementary lines that are not used for data exchange (lines 4-5, 7-8 in the example shown in FIG. 4). In Ethernet (registered trademark), there are cases where lines 4-5, 7-9 shown in FIG. 4 are used for data exchange.

Since in the configuration shown in FIG. 4, only the control signal is superimposed on the DC power supplied from center device 100 to remote terminal 200, HPF 106 and HPF 206 shown in FIG. 2 for extracting data signals are unnecessary. Since the other configuration and operation are the same as those in the power feeding system of the first exemplary embodiment, the description is omitted herein.

Also in the power feeding system of the second exemplary embodiment, similarly to the first exemplary embodiment, while control of power feeding to remote terminal 200 is implemented at center device 100, supply/suspension of power to main load 212 can be controlled by transmitting a control signal from center device 100 to remote terminal 200 when power is supplied to remote terminal 200, and it is also possible to control supply/suspension of power to main load 212, locally on the remote terminal 200 side by using power button 214 or sensor 215. Further, even if the ON/OFF state of switch 210 is different from the indication of the control signal transmitted to remote terminal 200, center device 100 can transmit a necessary control signal in accordance with the current ON/OFF state of switch 210. Accordingly, supply/suspension of power to main load 212 of remote terminal 200 can be controlled by both center device 100 and remote terminal 200.

Further, since the power feeding system of the present exemplary embodiment can be configured using versatile parts, the cost for remote terminal 200 will not increase.

Accordingly, it is possible for center device 100 to control the supply/suspension of power to main load 212 of remote terminal 200 without an increase in cost.

Although the present invention has been explained with reference to the exemplary embodiments, the present invention should not be limited to the above exemplary embodiments. Various modifications that can be understood by those skilled in the art may be made to the structures and details of the present invention within the scope of the present invention.

This application claims the priority of Japanese Patent Application No. 2010-186376 filed on Aug. 23, 2010, the disclosures of which are incorporated herein by reference.

1. A power feeding system comprising:
a remote terminal including a power-receiving side unit that receives externally supplied power, a main load as a circuit or device that realizes the principal function thereof, and a switch that connects said power-receiving side unit with said main load when said switch is on and disconnects said power-receiving side unit from the main load when said switch is off; and,
a center device including a power-sourcing side unit that performs power feed control to said remote terminal and a control signal transmitter that generates a control signal for controlling supply and suspension of power to said main load and for transmitting the control signal by superimposing the control signal on the power supplied from said power sourcing side unit to said remote terminal, and
said remote terminal further including
a control signal receiver that receives the control signal that is transmitted by being superimposed on the power supplied from said center device to turn said switch on or off in accordance with the control signal.

2. The power feeding system according to claim 1, wherein said power-sourcing side unit detects the load current flowing through said power-receiving side unit, and
said center device further includes a controller for determining whether or not power is supplied to said main load, based on the load current value detected by said power-sourcing side unit.

3. The power feeding system according to claim 2, wherein said controller determines that said remote terminal is connected when the load current flowing to said control signal receiver is detected and determines that said remote terminal is disconnected when the load current is not detected.

4. A power feeding method, wherein
a center device including a power-sourcing side unit for performing power feed control to a remote terminal, generates a control signal for controlling supply and suspension of power to a main load as a circuit or device that realizes the principal function of said remote terminal and transmits the control signal by superimposing the control signal on the power supplied to said remote terminal; and
said remote terminal includes a power-receiving side unit that receives externally supplied power, the main load, a switch that connects a power-receiving side unit with the main load when a switch is on and disconnects said power-receiving side unit from said main load when said switch is off, and a control signal receiver that receives the control signal that is transmitted by being superimposed on the power supplied from said center device,
said switch is turned on or off in accordance with the control signal received at said control signal receiver.

5. The power feeding method according to claim 4, wherein said power-sourcing side unit detects the load current flowing through said power-receiving side unit, and
said center device determines whether or not power is supplied to said main load, based on the load current value detected by said power-sourcing side unit.

6. The power feeding method according to claim 5, wherein said center device determines that said remote terminal is connected when the load current flowing to said control signal receiver is detected and determines that said remote terminal is disconnected when the load current is not detected.

7. A center device includes:
a power-feeding side device that performs power feed control to a remote terminal; and,
a control signal transmitter that generates a control signal for controlling supply and suspension of power to a main load as a circuit or device that realizes the principal function of said remote terminal, and
the control signal is transmitted by being superimposed on the power supplied from said power-sourcing side unit to said remote terminal.

8. The center device according to claim 7, wherein said power-sourcing side unit detects the load current flowing through said power-receiving side unit, and
includes a controller for determining whether or not power is supplied to said main load, based on the load current value detected by said power-sourcing side unit.

9. The center device according to claim 8, wherein said controller determines that said remote terminal is connected when the load current flowing to said control signal receiver is detected and determines that said remote terminal is disconnected when the load current is not detected.

10. A remote terminal being supplied with power from a center device, comprising:
a power-receiving side unit that receives power supplied form said center device;
a main load as a circuit or device that realizes the principal function thereof;
a switch that connects the power-receiving side unit with said main load when said switch is on and disconnects said power-receiving device from said main load when said switch is off; and,
a control signal receiver that receives the control signal that is transmitted by being superimposed on the power supplied from said center device to turn said switch on or off in accordance with the control signal.
